(19) United States
(12) Patent Application Publication
(10) Pub. No.: US 2026/0081071 A1
(43) Pub. Date: Mar. 19, 2026

(54) ELECTRONIC COMPONENT

(71) Applicant: TDK Corporation, Tokyo (JP)

(72) Inventors: Ryota NAMIKI, Tokyo (JP); Toshihiro IGUCHI, Tokyo (JP); Atsushi WATANABE, Tokyo (JP); Tomoyuki TANABE, Tokyo (JP); Yasuhiro ITO, Tokyo (JP)

(73) Assignee: TDK Corporation, Tokyo (JP)

(21) Appl. No.: 19/402,302

(22) Filed: Nov. 26, 2025

(30) Foreign Application Priority Data
Dec. 4, 2024 (JP) 2024-211601

(51) Int. Cl. H01G 4/008; H01G 4/30

(52) U.S. Cl. CPC H01G 4/008; H01G 4/30

(57) ABSTRACT

An electronic component including an element main body including an insulation layer and an electrode layer inside the element main body. A center side concentration of Mn in a center area of the electrode layer positioned near a center of the element main body is higher compared to an end side concentration of Mn in an end area of the electrode layer positioned near an end face of the element main body

### TECHNICAL FIELD

The present disclosure relates to an electronic component having an element main body which includes an insulation layer and an internal electrode layer.

### BACKGROUND

Electronic components such as a multilayer ceramic capacitor includes an element main body including an insulation layer such as dielectrics and an electrode layer inside the element main body. Due to difference in linear expansion coefficients, stress acts on areas near an end and a center along a lamination direction inside the element main body, and cracks may occur at the interface between the insulation layer and the electrode layer.

In Patent Document 1 below, thermal cracks are reduced while maintaining a good temperature characteristic by regulating a Mn concentration along the lamination direction.

### PRIOR ART DOCUMENT

### Patent Document

Patent Document 1: JP Patent Application Laid Open No. 2024-057740

### SUMMARY

An object of the present disclosure is to provide an electronic component capable of having fewer cracks in a high-temperature and high-humidity environment.

The present inventors have carried out keen study to reduce cracks under a high-temperature and high-humidity environment. As a result, the present inventors have found that it is important to regulate a Mn concentration from an end part of the electrode layer in the element main body toward a center of the element main body. Thereby, the present disclosure was achieved.

An electronic component according to the present disclosure includes: an element main body including an insulation layer and an electrode layer inside the element main body, wherein a center side concentration of Mn in a center area of the electrode layer positioned near a center of the element main body is higher compared to an end side concentration of Mn in an end area of the electrode layer positioned near an end face of the element main body.

In general, the electrode layer including metals such as Ni is difficult to bond with the insulation layer such as a dielectric layer; thus, the interface between the electrode layer and the insulation layer is prone to crack. According to the new findings by the present inventors, by including Mn in the electrode layer, the electrode layer and the insulation layer tend to bond easily, and cracks are expected to be reduced. However, since Mn tends to oxidize easily, a metal component of the electrode layer may be oxidized particularly at the end part of the electrode layer (near the end face of the element main body).

In the electronic component according to one aspect of the present disclosure, the center side concentration of Mn is higher compared to the end side concentration of Mn; thus, while enhancing the bonding strength between the electrode layer and the insulation layer, oxidation at the end of the electrode is suppressed, and particularly it is possible to reduce cracks under high-temperature high-humidity environment.

An end side concentration C1 of Mn may be between 0.01 to 0.15 atm %, or preferably between 0.02 to 0.08 atm %. Also, when the center side concentration of Mn is represented by C2; then, C2/C1 may between 1.1 to 20.0, between 1.5 to 20.0, or preferably between 3.0 to 15.0. When C1 and C2 satisfy such ranges, the effectiveness is particularly high.

A steep-change area, where a concentration of Mn drastically changes, may exist between the end area and the center area of the electrode layer, and the steep-change area and the end area may be continuous. When the electrode layer has such concentration distribution, the effectiveness is particularly high.

The steep-change area may appear in a range within 400 μm from the end face of the element main body. When the electrode layer has such concentration distribution, the effectiveness is particularly high.

A Mn concentration change rate (slope) in the steep-change area may be 0.1 atm %/mm or greater with respect to a distance (mm) along the electrode layer from the end face of the element main body. When the electrode layer has such concentration distribution, the effectiveness is particularly high.

A plateau area, where the concentration of Mn barely changes, may exist between the end area and the center area of the electrode layer, and the plateau area and the center area may be continuous. When the electrode layer has such concentration distribution, the effectiveness is particularly high.

The plateau area is observed in a range beyond 400 μm from the end face of the element main body. When the electrode layer has such concentration distribution, the effectiveness is particularly high.

A Mn concentration change rate in the plateau area with respect to a distance (mm) along the electrode layer from the end face of the element main body may be smaller than the Mn concentration change rate (slope) in the steep-change area.

The end side concentration may be an average of Mn concentrations obtained from three measuring points taking a predetermined space between each other along the electrode layer in the end area.

The center side concentration may be an average of Mn concentrations obtained from three measuring points taking a predetermined space between each other along the electrode layer in the center area.

A slope of a linear approximation in a two-dimensional coordinate may be 0.2 atm %/mm or greater and a coefficient of determination may be 0.75 or greater, provided that the two-dimensional coordinate is set using a distance along the electrode layer from the end face of the element main body as an x-axis and using a concentration of Mn in the electrode layer at each measuring point along the x-axis as a y-axis, and a linear approximation of y is carried out in a range of x between 20 μm to 100 μm. When such concentration distribution is satisfied, the effectiveness is particularly high.

A main component included in a conductor in the electrode layer may be Ni and/or a Ni-based alloy. When the electrode layer is configured as such, the effectiveness is particularly high.

The insulation layer may be a dielectric layer including Ca and Zr. When the insulation layer is configured as such, the effectiveness is particularly high.

### BRIEF DESCRIPTION DRAWINGS

FIG. 1A is a schematic view of a cross section of a multilayer ceramic capacitor according to one embodiment of the present disclosure.

FIG. 1B is a schematic view of a cross section of a multilayer ceramic capacitor according to another embodiment of the present disclosure.

FIG. 2 is a graph showing a linear approximation of Mn ratio in the internal electrode of a multilayer ceramic capacitor according to one embodiment of the present disclosure.

### DETAILED DESCRIPTION

Below describes the embodiments of the present disclosure.

### First Embodiment

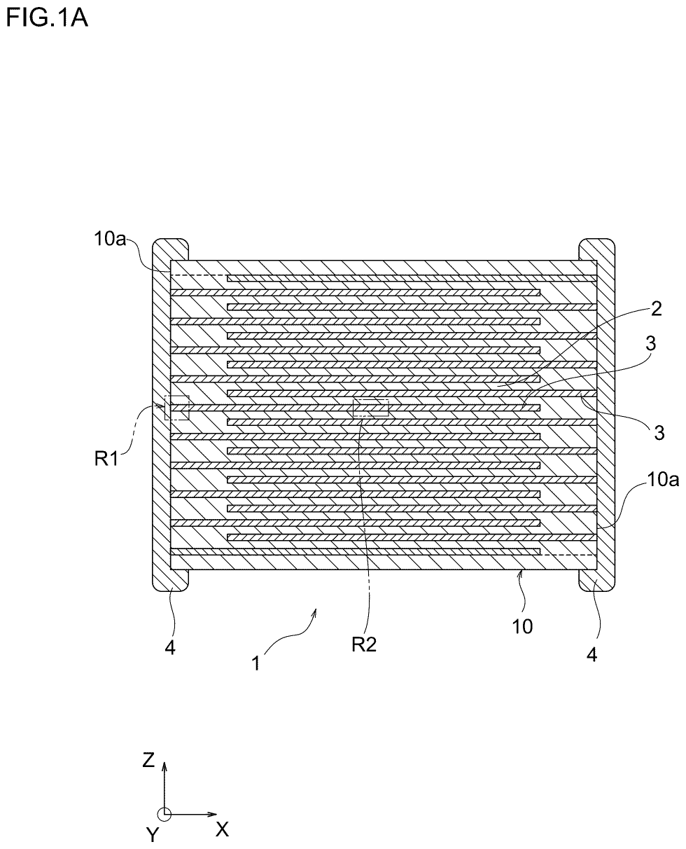

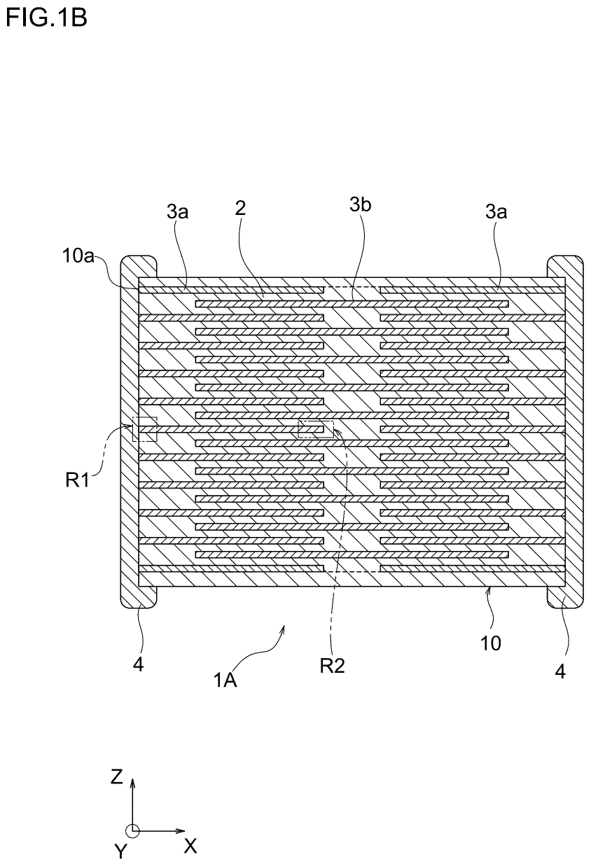

As shown in FIG. 1A, a multilayer ceramic capacitor 1 as one example of an electronic component according to the present embodiment includes an element main body 10, in which internal dielectric layers 2 as insulation layers and internal electrode layers 3 are alternately laminated. External electrodes 4 are provided along an X-axis to both ends 10a of this element main body 10.

The shape of the element main body 10 is not particularly limited, and normally it is a rectangular parallelepiped shape. The element main body 10 may be any other shape, such as an elliptic cylindrical shape, a cylindrical shape, or a prismatic shape. The dimensions of the element main body 10 is not particularly limited, and the dimensions are appropriately determined according to uses. For example, it can have a length of 0.4 mm to 5.7 mm in the X-axis direction, a width of 0.2 mm to 5.0 mm in the Y-axis direction, and a height TO of 0.5 mm to 3.0 mm in the Z-axis direction. In the present embodiment, the X-axis, the Y-axis, and the Z-axis are perpendicular to each other.

Among the plurality of internal electrode layers 3, one of the pair of internal electrode layers 3 which are facing each other in a lamination direction is connected to one of the external electrodes 4 at one end face 10a of the element main body 10. The other one of the pair of internal electrode layers 3 is connected to the other external electrode 4 at the other end face 10a of the element body 10.

More specifically, the internal electrode layers 3 are laminated so that each end is exposed to the end face 10a at the opposite side along the X-axis of the element main body 10. The internal electrode layers 3 are laminated having the dielectric layer 2 in between so that ends of the internal electrode layers 3 are alternatingly exposed to two end surfaces 10a of the element main body 10 facing each other in the X-axis direction. The external electrodes 4 are respectively formed on one end face of the element main body, and the external electrodes 4 are electrically connected to the exposed ends of the internal electrode layers 3 which are arranged alternatingly. The internal electrode layers 3 and the external electrodes 4 formed in such a manner configure a capacitor circuit.

A composition of the dielectric layer 2 is not particularly limited. In the present embodiment, the main component of the dielectric layer 2 preferably includes Ca and/or Sr, and Zr; preferably includes Ca and Zr; or preferably mainly includes Ca, Sr, Zr, and Ti. For example, the main component may be a perovskite compound including Ca only, or a combination of Ca and Sr as an A-site element, and Zr only or a combination of Zr and Ti as a B-site element. A perovskite compound is a compound having a perovskite-type crystal structure represented by a formula ABO₃ (where A includes A-site elements and B includes B-site elements).

In a situation where the dielectric layer 2 contains a perovskite compound including Ca and Sr as A-site elements, and Zr and Ti as B-site elements, a total ratio of Ca and Sr to all of the A-site elements of the perovskite compound may be 50 atm % or more. A total content ratio of Zr and Ti to all of the B-site elements of the perovskite compound may be 90 atm % or more.

More specifically, the dielectric layer 2 may be a compound that can be represented by a composition formula (Ca₁₋ₓSrₓ)ₘ(Zr_{1-y-z}Ti_{y}Hf₂)O₃ (hereinafter referred to as “CSZT based compound”). In the above-mentioned composition formula, x, y, z, and m are elemental ratios; and each elemental ratio is not particularly limited and can be determined within a known range.

For example, m represents the elemental ratio of the A-site to the B-site and can normally range from 0.9 to 1.1. Also, x represents the elemental ratio of Sr in the A-site, and can satisfy 0≤x≤1. That is, the ratio of Ca to Sr is determined freely; and only either one of the elements may be contained.

Also, y represents the elemental ratio of Ti in the B-site, and z represents the elemental ratio of Hf in the B-site. That is, 1−y−z represents the elemental ratio of Zr in the B-site. In the present embodiment, 0.80≤1−y−z≤1.0 is preferably satisfied. The elemental ratio of oxygen (O) in the above composition formula may slightly deviate from the stoichiometric composition.

Other than the above perovskite compound, the dielectric layer 2 may contain, for example, SiO₂ and/or Al₂O₃. Specifically, with respect to 100 parts by mol of B-site elements of the perovskite compound, the dielectric layer 2 may contain 0 parts by mol or more and 4.0 parts by mol or less of Si. Specifically, with respect to 100 parts by mol of B-site elements of the perovskite compound, the dielectric layer 2 may contain 0 parts by mol or more and 2.0 parts by mol or less of Al.

The dielectric layer may further include subcomponents. Examples of such subcomponents include a Mn compound, a Mg compound, a Ni compound, a Li compound, and a B compound. Further, a type, combination, or amount of the subcomponents is not particularly limited.

The internal dielectric layers 2 may have any thickness (interlayer thickness) per layer depending on desired characteristics, uses, etc. The thickness may be, for example, 0.5 μm or thicker and 20 μm or thinner, 1 μm or thicker and 20 μm or thinner, or 3.0 μm or thicker and 15 μm or thinner.

The external electrodes 4 may contain any conductor. For example, a known conductor such as Ni, Cu, Sn, Ag, Pd, Pt, Au, their alloys, or a conductive resin may be used. The thickness of the external electrode 4 is appropriately determined according to uses or the like.

In the present embodiment, the internal electrode layer 3 contains a conductor having a main component composed of metal (including alloy). The metal is not particularly limited, and examples of the metal include Cu, Ni, Ag, Pd, Au, Pt, or an alloy including at least one of these metals. The preferable metal may be Ni and/or a Ni-based alloy.

Also, the “main component of the conductor included in the internal electrode layer 3” refers to a component which a total of each element configuring the main component of the conductor included in the internal electrode layer 3 is 80 parts by mol with respect to the total of each element configuring the conductor included in the internal electrode layer 3 is 100 parts by mol.

The internal electrode layer 3 may contain about 0.1 mass % or less of various trace components, such as P. The thickness of the internal electrode layers 3 is appropriately determined according to uses or the like. The number of the internal electrode layers 3 is not particularly limited. The number may be 40 or more and 400 or less, or may be 50 or more and 300 or less.

In the multilayer ceramic capacitor according to the present embodiment, the internal electrode layer 3 include Mn. In the internal electrode layer 3 including Mn, a center side concentration of Mn in a center area R2 of the internal electrode layer 3 positioned near the center of the element main body 10 is higher compared to an end side concentration C1 of Mn in an end area R1 of the internal electrode layer 3 positioned near the end face 10a of the element main body 10.

In the case that the plurality of internal electrode layers 3 is laminated in a lamination direction (parallel to the Z-axis direction), the end area R1 of the internal electrode layer 3 is an area within a predetermined range (i.e., 0 to 20 μm) along the internal electrode layer 3 from the end face 10a of the element main body 10 regarding the internal electrode layer 3 closest to the center along the Z-axis. The end side concentration C1 of Mn is measured as an average of concentrations of Mn from three or more measuring points taking a predetermined distance between each other along the internal electrode layer 3 within the end area R1 of the internal electrode layer 3.

The center area R2 of the internal electrode layer 3 is an area within a predetermined range (i.e., 0 to 20 μm) along the same internal electrode layer 3, from which the end side concentration was measured, and includes the center along the X-axis (or the Y-axis) of the cross-section of the element main body 10. The center side concentration C2 of Mn is measured as an average of concentrations of Mn from three or more measuring points taking a predetermined distance between each other along the internal electrode layer 3 within the center area R2. A method for measuring such concentration will be described later.

In general, it is difficult to bond the internal electrode layer including metals such as Ni with an insulation layer such as a dielectric layer, and cracks easily occur at the interface between the internal electrode layer and the internal dielectric layer. According to the new finding by the present inventors, by including Mn in the internal electrode layer 3, the internal electrode layer and the dielectric layer can bond easily, and it is thought to be effective on reducing the cracks. However, since Mn tends to oxidize easily, the metal components in the internal electrode layer, particularly near the end part (near the end face of the element main body) of the internal electrode layer, may be oxidized.

In the multilayer ceramic capacitor 1 according to the present embodiment, the center side concentration C2 of Mn is higher compared to the end side concentration C1 of Mn; therefore, while the bonding strength between the internal electrode layer 3 and the internal dielectric layer 2 is enhanced, oxidation at the end part of the internal electrode layer 3 is suppressed, and cracks can be reduced particularly under high-temperature and high-humidity condition.

A coverage ratio refers to a ratio of the total length of the internal electrode layer 3 along a lamination interface with respect to a total length of the dielectric layer 2 along the lamination interface, when observing one ceramic layer 2 and one internal electrode layer 3 as a pair which are in contact with each other under a predetermined field of view of a cross-section (Y-Z plane or Z-X plane) parallel to the lamination direction (Z-axis direction) of the element main body 10. The length in the lamination direction of the predetermined field of view may be any length in which one dielectric layer 2 and one internal electrode layer 3 as a pair which are in contact with each other can be seen. The length in a direction parallel to the lamination direction of the predetermined field of view may be about 10 μm to about 500 μm. Observation is carried out preferably about five fields of view satisfying the above conditions to calculate an average coverage ratio of the internal electrode layers.

The end side concentration C1 of Mn may be between 0.01 and 0.15 atm %, or further preferably it may be between 0.02 and 0.08 atm %. Also, C2/C1 may be between 1.1 to 20.0, between 1.5 to 20.0, or preferably between 3.0 to 15.0. When C2/C1 is between this range, the effectiveness is particularly high.

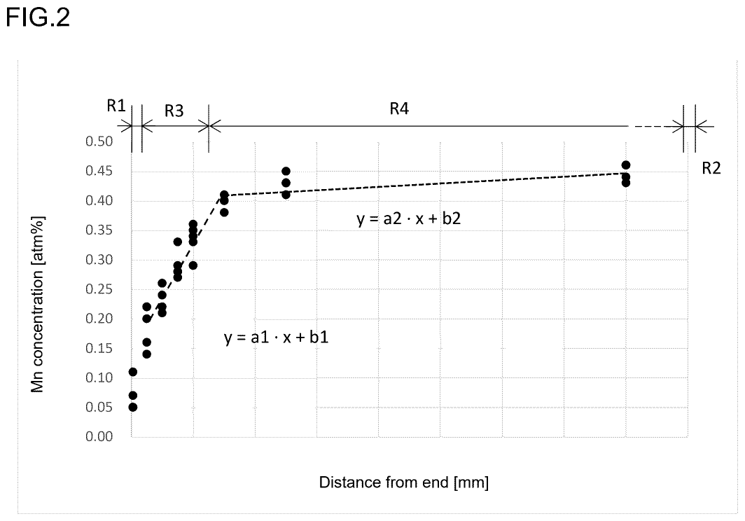

In the present embodiment, as shown in FIG. 2, in the internal electrode layer 3, a steep-change area R3, where the Mn concentration drastically increases, exists between the end area R1 and the center area R2. The steep-change area R3 and the end area R1 may be continuous. When such concentration distribution is satisfied, the effectiveness is particularly high.

As shown in FIG. 2, the steep-change area R3 appears within a range of 400 μm towards the center direction from the end face 10a of the element main body 10 shown in FIG. 1A, or within a range of 20 to 400 μm, 20 to 350 μm, 20 to 300 μm, 20 to 200 μm, or 20 to 100 μm. When such concentration distribution is satisfied, the effectiveness is particularly high.

In the steep-change area R3, a change rate (slope a1) of the Mn concentration with respect to a distance from the end face of the element main body along the electrode layer is preferably 0.1 atm %/mm or greater, 0.2 atm %/mm or greater, 0.3 atm %/mm or greater, 0.5 atm %/mm or greater, or 0.6 atm %/mm or greater. When such concentration distribution is satisfied, the effectiveness is particularly high.

In the present embodiment, the internal electrode layer 3 includes a plateau area R4, where the Mn concentration barely changes, between the end area R1 and the center area R2. The plateau area R4 and the center area R2 may be continuous. When such concentration distribution is satisfied, the effectiveness is particularly high. The plateau area R4 is already observed in the range beyond 400 μm from the end face 10a of the element main body 10 shown in FIG. 1A, and the steep-change area R3 may change to the plateau area R4 within a range 100 μm toward the inside from the end face 10a to the position 400 μm from the end face 10a. When such concentration distribution is satisfied, the effectiveness is particularly high.

In the plateau area R4, a change rate (slope a2) of the Mn concentration with respect to a distance (mm) from the end face 10a of the element main body 10 along the internal electrode layer 3 is smaller than the change rate (slope) of the Mn concentration in the steep-change area R3, and preferably it may be within ±0.08 atm %/mm, within ±0.05 atm %/mm, or within ±0.03 atm %/mm. When such concentration distribution is satisfied, the effectiveness is particularly high.

In the present embodiment, the slope of a linear approximation in a two-dimensional coordinate is 0.2 atm %/mm or greater and a coefficient of determination may be 0.75 or greater, provided that the two-dimensional coordinate is set using a distance along the electrode layer 3 from the end face 10a of the element main body as an x-axis and using a concentration of Mn in the electrode layer at each measuring point along the x-axis as a y-axis, and a linear approximation of y is carried out in a range of x between 20 μm to 100 μm.

Specifically, as shown in FIG. 2, the concentration of Mn at the measuring point is plotted using the distance from the end face 10a (the exposing end of the internal electrode layer) of the element main body 10 as the x-axis (horizontal axis) and using the concentration of Mn as the y-axis (vertical axis). For example, in the steep-change area R3, the slope a1 is preferably within the above-mentioned range, when linear approximation is performed using a least-square method so that y=a1·x+b1 is satisfied based on the data where x is between 20 μm to 100 μm. Also, preferably the coefficient of determination is 0.75 or greater, or 0.8 or greater.

Also, in the plateau area R4 of the internal electrode layer 3, preferably the Mn concentration is substantially constant. That is, in the two-dimensional coordinate, when linear approximation is carried out so that y=a2·x+b2 is satisfied, based on the plateau area R4 of the internal electrode layer, where x is 400 μm or greater, the slope a2 is preferably between-0.08 atm %/mm or greater and +0.08 atm %/mm or less as already mentioned.

In a preferable embodiment, a main component of a conductor in the internal electrode layer 3 includes Ni and/or a Ni-based alloy. When the internal electrode layer is configured as such, the effectiveness is particularly high. Also, the internal dielectric layer 2 includes Ca and Zr. When the internal dielectric layer 2 is configured as such, the effectiveness is particularly high.

There is no particular limitation regarding a method for measuring the concentration of Mn along the longitudinal direction of the cross section of the internal electrode layer 3 including the end side concentration C1 and the center side concentration C2 of Mn. Examples of the method for measuring the Mn concentration include a method for measuring the intensity of a characteristic X-ray of Mn using an Electron Probe Micro analyzer (EPMA), SEM-EDS, or STEM-EDS.

The intensity of the characteristic X-ray of Mn is proportional to the Mn concentration. Thus, the Mn concentration in each area can be calculated by carrying out a line analysis of the intensity of the characteristic X-ray of Mn in the internal electrode layers along the thickness direction of the external electrodes 4 (the direction along the X-axis of FIG. 1A) to calculate the average of a plurality of areas. Note that, in the case that the plurality of numbers of the internal electrode layers 3 are laminated, the Mn concentrations of two to five areas in the internal electrode layers 3 near the center along the Z-axis may be averaged, and thereby C1 and C2 may be calculated.

In the above line analysis, distances between the measuring points along the X-axis (or Y-axis) of the characteristic X-ray can be shortened sufficiently, and specifically it may be 2 μm or less. In the present embodiment, the concentration of Mn is measured as atm % of Mn when a total of metal elements in the main component, such as Ni and Mn, included in the internal electrode layer 3 is 100 atm %.

An example method of manufacturing the multilayer ceramic capacitor 1 shown in FIG. 1A is described next.

First, steps of manufacturing the element main body 10 are described. In the steps of manufacturing the element main body 10, a dielectric paste to be the dielectric layers 2 after firing and an internal electrode paste to be the internal electrode layers 3 after firing are prepared.

The dielectric paste is prepared, for example, as follows. First, dielectric raw materials are uniformly mixed by, for example, wet-mixing and are dried. The resultant mixture is then subject to a heat treatment under predetermined conditions to give a calcined powder. Then, a known organic vehicle or a known water-based vehicle is added to the resultant calcined powder, and this mixture is kneaded to prepare the dielectric paste.

The dielectric paste obtained in this manner is turned into sheets using, for example, a doctor blade method to give ceramic green sheets. As necessary, the dielectric paste may contain additives selected from various dispersants, plasticizers, dielectrics, subcomponent compounds, glass frit, etc.

Then, on the ceramic green sheets, the internal electrode paste is applied in a predetermined pattern using a printing method such as screen printing or a transfer method to form internal electrode patterns. The internal electrode paste is configured of a paste including conductor particles including metals (including alloy) such as Ni, and a known organic vehicle or a known water-based vehicle may be added to the conductor particles and kneaded to form the internal electrode paste.

In the present embodiment, there is no particular limitation regarding a method to form a concentration pattern of the Mn concentration in the internal electrode layer 3 as shown in FIG. 2, and examples include the two below described methods.

As a first manufacturing method, a method using a spattering method may be mentioned. Specifically, Mn is deposited on a pattern surface of the internal electrode paste by spattering to attain Mn concentration gradient shown in FIG. 2 after firing from the end toward the center of the green sheet where the pattern of the internal electrode paste is printed on.

As a second manufacturing method, a method which divides the printing of the internal electrode paste may be mentioned. Specifically, the internal electrode pastes with different Mn concentrations are separately printed on the internal electrode paste pattern from the center to the end of the pattern, and the patterns of the paste are connected.

Such ceramic green sheets with the pattern of the internal electrode parts are laminated, and this laminate is pressed in the lamination direction to give a mother laminated body. Note that, at this time, exterior green sheets are laminated so that, the ceramic green sheets are positioned at upper and lower surfaces of the mother laminated body in the lamination direction.

The mother laminated body obtained through the above steps is cut into predetermined dimensions by dicing or push-cutting to give green chips. As necessary, the green chips may be subject to solidification drying to remove plasticizers or the like and may then be subject to barrel polishing using a horizontal centrifugal barrel machine or the like. In barrel polishing, the green chips are put into a barrel together with media and a polishing liquid, and a rotational movement or vibration is applied to the barrel. This removes unwanted parts such as burrs generated during cutting. The green chips after barrel polishing are washed with a cleaning solution such as water, and are dried.

Then, each of the resultant green chips is subject to a binder removal treatment and a firing treatment to give the element main body 10. Conditions of the binder removal treatment are appropriately determined according to the main component composition of the dielectric layers 2 or the main component composition of the internal electrode layers 3 and are not particularly limited. For example, the temperature increase rate is preferably 5° C./hour to 300° C./hour; the holding temperature is preferably 180° C. to 400° C.; and the temperature holding time is preferably 0.5 hours to 24 hours. The binder removal atmosphere is air or a reducing atmosphere.

Conditions of the firing treatment are appropriately determined according to the main component composition of the dielectric layer 2 or the main component composition of the internal electrode layer 3, and are not limited. For example, the holding temperature during firing is preferably 1100° C. to 1400° C., or more preferably 1220° C. to 1300° C.; the holding time during firing is preferably 0.5 hours to 8 hours, or more preferably 1 hour to 3 hours; and the temperature increasing rate and the cooling rate (temperature decreasing rate) are preferably 50° C./hour to 500° C./hour. The firing atmosphere is preferably a reducing atmosphere, and as an ambient gas, for example, a humidified mixed gas of N₂ and H₂ can be used. Further, in a situation where the internal electrode layer 3 is composed of a base metal such as Ni or a Ni-based alloy, the oxygen partial pressure of the firing atmosphere is preferably 2.0×10⁻¹³ atm to 1.0×10⁻⁷ atm.

After firing, the resultant element main body 10 may be subject to a reoxidation treatment (annealing) as necessary. As for annealing conditions, for example, the oxygen partial pressure while annealing is preferably higher than that of while firing, and the holding temperature is preferably 1150° C. or lower.

In the above binder removal treatment, firing treatment, and annealing treatment, for example, a wetter is used to humidify the N₂ gas, the mixed gas, or the like; and the water temperature is preferably between 5° C. and 75° C. or so. The binder removal treatment, firing treatment, and annealing treatment may be carried out continuously or independently.

The resultant element main body 10 is subject to end surface polishing, and an external electrode paste is applied there and is baked to form the external electrode 4. On a surface of the external electrode 4, a coating layer is formed by plating or the like as necessary.

The above steps give the multilayer ceramic capacitor 1 including the external electrode 4.

The resultant multilayer ceramic capacitor 1 can be surface-mounted on a substrate such as a printed wiring board by using solder (including molten solder, solder cream, and a solder paste) or by using a conductive adhesive, and thereby the multilayer ceramic capacitor 1 can be in various electronics. Alternatively, the multilayer ceramic capacitor 1 can be mounted on a substrate by using a wire-shaped lead terminal or a plate-shaped metal terminal.

Particularly, in a situation where the internal electrode layer 3 contains Ni in the internal electrode layer, Mn included in the surface or inside of the internal electrode layer 3 tends to easily form alloy with Ni included in the internal electrode layer 3. Due to this alloy of Mn and Ni, the bonding strength between the internal electrode layer 3 and the internal dielectric layer 2 can be enhanced, and it is thought that this allows to reduce the occurrences of cracking.

Because an electronic device including internal dielectric layer 2 which is composed of a CSZT based compound has a lower rate of change of permittivity according to temperature than that of an electronic device including internal dielectric layer 2 composed of barium titanate (hereinafter referred to as “BT-based compound”), thus the former electronic device tends to be used at high frequencies.

As such, it is preferable to use the internal dielectric layer 2 configured of the CSZT-based compound under high frequency; however, because a difference in linear thermal expansion coefficients between the CSZT-based compound and Ni is larger than a difference in linear thermal expansion coefficients between the BT-based compound and Ni, provided that the main component included in the conductor of the internal electrode layer 3 includes Ni and/or the Ni-based alloy, cracks are more likely to occur when the main component of the internal dielectric layer 2 is the CSZT-based compound than when the main component of the ceramic layer is the BT-based compound.

Further, in a situation where the main component of the internal dielectric layer 2 is the CSZT-based compound, the internal dielectric layer 2 may contain Mn; and Mn may be contained particularly in the main phase grains composed of the CSZT-based compound by being solid-dissolved therein, or Mn may be contained in the grain boundary. In the present embodiment, Mn contained in the main phase grains and/or the grain boundary or the like of the internal dielectric layer 2 and Mn contained in the internal electrode layer 3 undergo mutual diffusion. Thus, the bonding strength between the internal electrode layer 2 and the internal electrode layer 3 can be further enhanced. This can further reduce cracks.

In the present embodiment, compared to the center side concentration of Mn, the end side concentration of Mn is lower, therefore, while the bonding strength between the internal electrode layer 3 and the internal dielectric layer 2 is enhanced, oxidation at the end part of the internal electrode layer is suppressed, and particularly cracks can be reduced under high-temperature and high-humidity condition.

### Second Embodiment

As shown in FIG. 1B, a multilayer ceramic capacitor 1A as an example of an electronic component according to the present embodiment have basically the same configurations and exhibits the same effects as the multilayer ceramic capacitor 1 shown in FIG. 1A; except that the multilayer ceramic capacitor 1A has a different arrangement pattern of internal electrode layers 3a and 3b compared to that of the multilayer ceramic capacitor 1 of the embodiment shown in aforementioned FIG. 1A. Below describes the parts which are different from the first embodiment.

The capacitor 1A of the present embodiment has an element main body 10 in which the internal electrode layers 3a and 3b having two types of patterns are laminated in an alternating manner while placing the internal dielectric layer 2 in between. The internal electrode layer 3a is connected to both of the pair of external electrodes 4 at both ends in the X-axis direction.

Also, the internal electrode layer 3b contains a pattern which covers an insulation pattern portion insulated in the middle of the internal electrode layer 3a along the X-axis direction, and it may not connect to neither of the external electrodes 4 at the ends of the X-axis direction. In such capacitor 1A, the area of the internal dielectric layer 2 where the internal electrode layer 3a and the internal electrode layer 3b overlap when it is viewed from the Z-axis direction contributes to the capacity of the capacitor.

In the present embodiment, among the plurality of internal electrode layers 3a laminated along the Z-axis, for example, the end area R1 of the internal electrode layer(s) 3a positioned near the end face 10a of the element main body 10 is defined in a single internal electrode layer 3a or a plurality of internal electrode layers 3a positioned near the center along the Z-axis. Also, the center area R2 is defined in part of the internal electrode layer 3a closest to the center position along the X-axis of the element main body 10 in the internal electrode layer 3a from which the Mn concentration is measured and contains the end area R1.

In the present embodiment, regarding the internal electrode layer 3b, the end face of the element main body 10 is not exposed; hence, there may be no Mn concentration gradient; and the concentration of Mn may be consistently as high as the concentration of Mn in the center area R2.

Note that, when the ends along the Y-axis of the internal electrode layer 3a or 3b expose at the outer surface of the element main body 10, preferably the Mn concentration gradient as shown in FIG. 2 exists not only in the X-axis direction but also along the Y-axis direction. Also, in such case, the end long the Y-axis of the internal electrode layer 3a or 3b of the element main body 10 is preferably covered with a side margin layer such as a glass layer or a ceramic layer. This is the same for the element main body 10 of the first embodiment, and when the end along the Y-axis of the internal electrode layer 3 is exposed from the outer surface of the element main body 10, preferably the Mn concentration gradient as shown in FIG. 2 exists not only in the Y-axis direction but also along the X-axis direction.

Embodiments of the present disclosure have been described above; however, the present disclosure is not limited to the above embodiments and can be variously modified without departing from the gist of the present invention.

While the multilayer ceramic capacitor 1 is used as one example of an electronic device in the present embodiment, an electronic device of the present disclosure may be a band-pass filter, a multilayer three-terminal filter, a piezoelectric element, a thermistor, a varistor, etc.

While the internal dielectric layers 2 and the internal electrode layers 3 are laminated in the Z-axis direction in the present embodiment, the lamination direction may be the X-axis direction or the Y-axis direction. In this case, the external electrodes 4 are formed according to the exposed end surfaces of the internal electrode layers 3. Also, the element main body 10 does not necessarily have to be a laminated body, and it may be configured of a single layer. Moreover, the internal electrode layers 3 may be drawn out to an outer surface of the element main body 10 via through-hole electrodes. In such case, the through hole electrodes and the external electrodes 4 are electrically connected.

### EXAMPLES

Hereinafter, the present disclosure is described based on more detailed examples; however, the present disclosure is not limited to these examples.

### Example 1

A raw material powder (hereinafter which may be referred to as “main component raw material powder”) of a perovskite compound contained as a main component of dielectric layer main phase grains was produced. Specifically, a raw material powder of a Ca oxide, a raw material powder of a Sr oxide, a raw material powder of a Zr oxide, and a raw material powder of a Ti oxide were prepared and were weighed to provide the perovskite compound having a composition formula of (Ca_{0.70}Sr_{0.30})(Zr_{0.97}Ti_{0.03})O₃. Then, the powders were dispersed in purified water, were dried, and were further subject to a heat treatment (holding temperature: 1200° C. to 1250° C., holding time: 0.5 hours to 5 hours) to give the main-component raw material powder having a specific surface area of about 5.0 m²/g measured using a BET adsorption method. The holding temperature and the holding time of the heat treatment were set appropriately for each sample.

Additionally, a MnCO₃ powder, a SiO₂ powder, and an Al₂O₃ powder were prepared as subcomponents. The powders were weighed so that the Si content was larger than the Al content in terms of the number of atoms. Also, the MnCO₃ powder was prepared and weighed to give Mn content of 1.5 to 3.0 parts by mole.

The main component raw material powder and the powders of oxides of subcomponents were dispersed in purified water, were dried, and were further subject to a heat treatment to give a dielectric powder. The holding temperature was 400° C., and the holding time was 0.5 to 5 hours. The holding time of the heat treatment was appropriately determined for each sample.

The dielectric powder and an organic vehicle were mixed to give a dielectric paste. With respect to 100 parts by mass of the dielectric powder, 10 parts by mass of the polyvinyl butyral resin, 5 parts by mass of dioctyl phthalate (DOP) as a plasticizer, and 100 parts by mass of alcohol as a solvent were mixed using a ball mill; and the mixture was turned into a paste to give the dielectric paste.

Next, the internal electrode paste was prepared. A method of preparing an internal electrode paste was as follows. First, a Ni powder, a MnCO₃ powder, terpineol, ethyl cellulose, and benzotriazole were prepared. These were kneaded using a triple-roll mill and were turned into a paste to give the internal electrode paste.

Then, using the above-mentioned dielectric paste and internal electrode paste, the internal electrode paste was printed in a predetermined pattern on the surface of a dielectric green sheet. At this time, Mn was deposited on a pattern surface of the internal electrode paste by spattering from the end to the center of the green sheet where the pattern of the internal electrode paste was printed on in order to attain Mn concentration gradient as shown in FIG. 2 after firing (a manufacturing method A). Further, the green sheet on which the pattern of the internal electrode paste formed by depositing Mn in a predetermined pattern as mentioned in above was laminated. This provided the green chip.

The green chip was subject to a binder removal treatment, a firing treatment, and an annealing treatment to obtain an element main body 10 having a rectangular parallelepiped shape with a dimension of 3.2 mm×2.5 mm in a plane perpendicular to the lamination direction and having a length in a lamination direction of 2.5 mm.

The holding temperature during the firing treatment was 1250° C., the holding time was 2.0 hours, and the firing atmosphere was a reducing atmosphere having an oxygen partial pressure of 2.0×10⁻¹³ atm or greater and 1.0×10⁻⁷ atm or less. Also, in the obtained element main body 10, the laminated number of internal dielectric layers was 200, and the thickness of the dielectric layer between the internal electrode layers was 8 μm.

Then, on outer surfaces of the above element main body 10, a baked electrode layer containing Cu, a Ni plating layer, and a Sn plating layer were formed in this order to form external electrodes 4. Thereby, the multilayer ceramic capacitor 1 was obtained.

### (Composition of Dielectric Ceramic Composition)

Regarding the composition of the dielectric ceramic composition, a composition analysis of the internal dielectric layer was carried out using ICP optical emission spectroscopy. The analysis confirmed that the perovskite compound was contained in the internal dielectric layer satisfied the above composition. The analysis also confirmed that the content of additional element elements matched the content in the dielectric paste.

### (Concentration of Mn)

Regarding the concentration of Mn in the internal electrode layer 3, in the cross section shown in FIG. 1A, that is the cross section parallel to the lamination direction and parallel to the thickness direction of the external electrodes, a line analysis was carried out using mapping of STEM-EDS and EPMA to the area including a length of 1600 μm from the end in the X-axis direction of the internal electrode layer 3 towards the center of the element main body 10 (i.e., the area from the end area R1 to the steep-change area R3 and the plateau area R4 shown in FIG. 2) and the center area R2 shown in FIG. 1A. Thereby, the concentration of Mn (which is atm % when the Mn+Ni is 100 atm %) was measured.

The Mn average concentrations C1 and C2 were measured respectively from the end area R1 and the center area R2. When the concentration proportion C2/C1 was less than 1.1, then it was defined as “none” to indicate that there was no concentration difference, and when the concentration proportion C2/C1 was 1.1 or greater. it was defined as “confirmed” to indicate that the concentration difference was confirmed. Results are shown in Table 1A. Also, FIG. 2 shows one example of the line analysis result of the area from the end area R1 to the steep-change area R3 and the plateau area R4 in the internal electrode layer 3.

Further, based on the data within the range of x between 20 μm or larger and 100 μm or smaller (including the steep-change area R3), from the graph of two-dimensional coordinate shown in FIG. 2 which was obtained using the measurement result, a linear approximation using a least-square method so as to satisfy y=a1·x+b1 was carried out to calculate a slope a1.

Similarly, the plateau area R4 of the internal electrode layer 3, that is based on the data where x was 400 μm or greater, the linear approximation was carried out so as to satisfy y=a2·x+b2 to obtain a slope a2. Also, regarding the steep-change area R3 where the slope a1 was obtained, a coefficient of determination was obtained using a statistical method. The results are shown in FIG. 1A.

### (Exterior Inspection and PCT Test)

One hundred capacitor samples manufactured under the same conditions were subject to an exterior inspection by visually observing whether there were cracks on the outside. Results are shown in Table 1A.

Also, regarding one hundred capacitor samples manufactured under the same conditions, a crack occurrence ratio was calculated which was after 24 hours of PCT (pressure cooker test) in order to evaluate the crack occurrence ratio under the high temperature-high humidity environment.

For PCT, the capacitor sample was mounted on a FR4 substrate (glass epoxy substrate) using Sn—Ag—Cu solder and were introduced in a pressure cooker tank to conduct an accelerated moisture resistance load test at 121° C. and a humidity of 95% for 24 hours. One hundred capacitor samples were subject to the test. Table 1A shows the number of capacitor samples which the cracks were generated. In the present examples, the crack occurrence ratio after the 24-hour PCT was preferably 10% or less, more preferably 3% or less, or particularly preferably 0%.

### (Coverage Ratio)

In the predetermined field of view of the cross section parallel to the lamination direction (Z-axis direction) of the element main body 10 (Z-X plane shown in FIG. 1A), regarding a dielectric layer 2 and an internal electric layer 3 in a pair which were in contact with each other, a proportion of a total length of internal electrode layer 3 along the lamination interface to the total length of the dielectric layer 2 along the lamination interface was calculated. The obtained proportion was defined as the coverage ratio. Results are shown in Table 1A.

Note that, the length in the lamination direction of the predetermined field of view was a length which enabled to confirm a dielectric layer 2 and an internal electrode layer 3 as a pair adjacent to each other. About five field of views satisfying the predetermined field of view were observed, and the average coverage ratio of the internal electrode layer 3 was calculated. Results are shown in Table 1A.

### Example 2

A capacitor sample was manufactured similar to Example 1 except that a spattering method was not used.

In this Example 2, a plurality of types of internal electrode paste each having different Mn content was prepared. The internal electrode pastes were printed separately starting with low Mn concentration from the center to the end of the pattern of the internal electrode paste. Thereby, the pattern of internal electrode paste layer was formed on the green sheet (a manufacturing method B). In the paste layer portion corresponding to the end area R1 of the internal electrode layer, an internal electrode paste without Mn was used, and an internal electrode paste containing Mn was used for the steep-change area R3, the plateau area R4, and the center area R2. Other than these, the capacitor sample of Example 2 was manufactured similar to Example 1, and the similar evaluations were carried out. Results are shown in Table 1A.

### Comparative Example 1a

A capacitor sample was manufactured similar to Example 1 except for the points described below.

In this Comparative Example 1a, the capacitor sample was manufactured similar to Example 1 except that Mn spattering which was carried out in Example 1 was not carried out (a manufacturing method X1), and similar evaluations were carried out. Results are shown in Table 1A.

### Comparative Example 1b

A capacitor sample was manufactured similar to Example 2 except for the points described below.

In this Comparative Example 1b, among the internal electrode pastes with two different Mn contents used in Example 2, the internal electrode paste containing Mn was only used, and the pattern of the internal electrode paste layer was printed on the green sheet (a manufacturing method X2). Other than this, the capacitor sample of Comparative Example 1b was manufactured similar to Example 2 and the similar evaluations were carried out. Results are shown in Table 1A.

TABLE 1A

| | | Internal electrode layer | | | | | Steep-change area |
|---|---|---|---|---|---|---|---|
| | Manufacturing | Main | Additional | Concentration | C1 | C2/ | Slope a1 |
| Sample No. | method | component | element | difference | (at %) | C1 | (at %/mm) |
| Comparative | X1 | Ni | None | None | 0.00 | 0.0 | — |
| example 1a | | | | | | | |
| Example 1 | A | Ni | Mn | Confirmed | 0.08 | 8.3 | 0.61 |
| Example 2 | B | Ni | Mn | Confirmed | 0.07 | 8.0 | 0.59 |
| Comparative | X2 | Ni | Mn | None | 0.01 | 1.0 | — |
| example 1b | | | | | | | |

| | Steep-change area | Plateau area | | Crack occurence ratio | |
|---|---|---|---|---|---|
| | Coefficient of | Slope a2 | Coverage | Exterior | PCT (121° C., |
| Sample No. | determination | (at %/mm) | ratio (%) | inspection | 95% RH, 24 h) |
| Comparative | — | — | 90.3 | 2/100 | 17/100 |
| example 1a | | | | | |
| Example 1 | 0.86 | 0.01 | 90.5 | 0/100 | 0/100 |
| Example 2 | 0.82 | 0.03 | 91.2 | 0/100 | 0/100 |
| Comparative | — | — | 89.5 | 3/100 | 21/100 |
| example 1b | | | | | |

### Evaluation 1

As shown in Table 1A, compared to Comparative Examples 1a and 1b, Examples 1 and 2 had low crack occurrence ratios after exterior inspection, and also it was confirmed that cracks were reduced under high temperature-high humidity condition.

### Comparative Examples 2 to 4

Capacitor samples of Comparative Examples 2 to 4 were manufactured similar to Example 1, and the similar evaluations were carried out; except that Al, Mg, and Si were used for spattering instead of Mn. Results are shown in Table 1B.

TABLE 1B

| | | Internal electrode layer | | | Crack occurence ratio | |
|---|---|---|---|---|---|---|
| | Manufacturing | Main | Additional | Concentration | Exterior | PCT (121° C., |
| Sample No. | method | component | element | difference | inspection | 95% RH, 24 h) |
| Example 1 | A | Ni | Mn | Confirmed | 0/100 | 0/100 |
| Comparative | A | Ni | Al | Confirmed | 1/100 | 16/100 |
| example 2 | | | | | | |
| Comparative | A | Ni | Mg | Confirmed | 5/100 | 15/100 |
| example 3 | | | | | | |
| Comparative | A | Ni | Si | Confirmed | 3/100 | 18/100 |
| example 4 | | | | | | |

### Evaluation 2

As shown in Table 1B, compared to Comparative Examples 2 to 4, Examples 1 and 2 had lower crack occurrence ratios after exterior inspection, and also it was confirmed that cracks were reduced under high temperature-high humidity condition.

### Examples 3 and 4

Capacitor samples of Examples 3 and 4 were manufactured similar to Example 1, and the similar evaluations were carried out; except that CaZrO₃ and BaTiO₃ were used instead of (Ca_{0.70}Sr_{0.30})(Zr_{0.97}Ti_{0.03})O₃. Results are shown in Table 1C.

### Comparative Examples 5 and 6

Capacitor samples of Comparative Examples 5 and 6 were manufactured similar to Comparative Example 1, and the similar evaluations were carried out; except that CaZrO₃ and BaTiO₃ were used instead of (Ca_{0.70}Sr_{0.30})(Zr_{0.97}Ti_{0.03})O₃. Results are shown in Table 1C.

TABLE 1C

| | | Dielectric layer | Internal electrode layer | | | Crack occurence ratio | |
|---|---|---|---|---|---|---|---|
| | Manufacturing | Main | Main | Additional | Concentration | Exterior | PCT (121° C., |
| Sample No. | method | component | component | element | difference | inspection | 95% RH, 24 h) |
| Example 1 | A | (Ca0.7Sr0.3)(Zr0.97Ti0.03)O3 | Ni | Mn | Confirmed | 0/100 | 0/100 |
| Example 3 | A | CaZrO3 | Ni | Mn | Confirmed | 0/100 | 0/100 |
| Comparative | X | CaZrO3 | Ni | Mn | None | 4/100 | 22/100 |
| example 5 | | | | | | | |
| Example 4 | A | BaTiO3 | Ni | Mn | Confirmed | 0/100 | 4/100 |
| Comparative | X | BaTiO3 | Ni | Mn | None | 3/100 | 20/100 |
| example 6 | | | | | | | |

### Evaluation 3

As shown in Table 1C, compared to Comparative Examples 5 and 6, Examples 3 and 4 had lower crack occurrence ratios after exterior inspection, and also it was confirmed that cracks were reduced under high temperature-high humidity condition. Compared to Example 4, Examples 1 and 3 had lower crack occurrence ratio after exterior inspection, and also it was confirmed that cracks were reduced under high temperature-high humidity condition.

### Examples 5 to 12

Capacitor samples were manufactured similar to Example 1, and the similar evaluations were carried out; except that C1 and C2/C1 were controlled by adjusting the spattering amount of Mn. Results are shown in Table 2.

Also, for these examples, oxidation of the electrodes was observed using a metallurgical microscope. Specifically, the center part of the LT cross section of the capacitor sample was exposed and mirror polished, and the image of the end part was taken using the metallurgical microscope. From the obtained image, it was verified using at least twenty internal electrodes to verify whether the area with no metallic shining existed. Then, the distance from the end in the X-axis direction of the internal electrode layer to the area with no metallic shining closest from the end was determined. Here, in the case that no metallic shining was observed in the internal electrode layer, the distance was deemed 0. This process was carried out to ten capacitors, and the median of the distances was considered as an end part oxidation distance. Results are shown in Table 2. In the present examples, the end part oxidation distance is preferably 0.0 μm.

TABLE 2

| | | | | | Crack occurence ratio | | End |
|---|---|---|---|---|---|---|---|
| | | | | | | PCT | oxidation |
| | Manufacturing | Concentration | C1 | C2/ | Exterior | (121° C., 95% | Distance |
| Sample No. | method | difference | (at %) | C1 | inspection | RH, 24 h) | [μm] |
| Example 5 | A | Confirmed | 0.02 | 1.5 | 0/100 | 8/100 | 0.0 |
| Example 6 | A | Confirmed | 0.05 | 2.1 | 0/100 | 7/100 | 0.0 |
| Example 7 | A | Confirmed | 0.03 | 3.2 | 0/100 | 0/100 | 0.0 |
| Example 1 | A | Confirmed | 0.08 | 8.3 | 0/100 | 0/100 | 0.0 |
| Example 8 | A | Confirmed | 0.06 | 14.2 | 0/100 | 0/100 | 0.0 |
| Example 9 | A | Confirmed | 0.04 | 19.8 | 0/100 | 9/100 | 0.0 |
| Example 10 | A | Confirmed | 0.15 | 8.5 | 0/100 | 0/100 | 0.0 |
| Example 11 | A | Confirmed | 0.18 | 8.6 | 0/100 | 2/100 | 3.4 |
| Example 12 | A | Confirmed | 0.31 | 7.9 | 0/100 | 1/100 | 4.7 |

### Evaluation 4

As shown in Table 2, it was confirmed that C1 may be between 0.01 to 0.15 atm %, or preferably between 0.02 to 0.08 atm %. It was also confirmed that C2/C1 may be between 1.1 to 20.0, between 1.5 to 20.0, or preferably between 3.0 to 15.0.

### Examples 13 to 17

Capacitor samples were manufactured similar to Example 1, and the similar evaluations were carried out; except that C2/C1, a slope a1, and a coefficient of determination were controlled by adjusting the spattering amount of Mn. Results are shown in Table 3.

TABLE 3

| | | | | Steep-change area | | Plateau area | | Crack occurence ratio | |
|---|---|---|---|---|---|---|---|---|---|
| | Concentration | C1 | C2/ | Slope a1 | Coefficient of | Slope a2 | Coverage | Exterior | PCT (121° C., |
| Sample No. | difference | (at %) | C1 | (at %/mm) | determination | (at %/mm) | ratio (%) | inspection | 95% RH, 24 h) |
| Example 13 | Confirmed | 0.08 | 8.0 | 0.08 | 0.70 | −0.01 | 92.3 | 0/100 | 8/100 |
| Example 14 | Confirmed | 0.07 | 7.9 | 0.05 | 0.89 | 0.03 | 91.5 | 0/100 | 10/100 |
| Example 15 | Confirmed | 0.03 | 8.5 | 0.35 | 0.68 | 0.02 | 90.8 | 0/100 | 9/100 |
| Example 16 | Confirmed | 0.04 | 9.1 | 0.65 | 0.76 | −0.02 | 90.7 | 0/100 | 0/100 |
| Example 1 | Confirmed | 0.08 | 8.3 | 0.61 | 0.86 | 0.01 | 90.5 | 0/100 | 0/100 |
| Example 17 | Confirmed | 0.06 | 8.7 | 0.75 | 0.91 | 0.01 | 91.0 | 0/100 | 0/100 |

### Evaluation 5

As shown in Table 3, it was confirmed that C2/C1 was between 1.1 to 20.0, between 1.5 to 20.0, or preferably between 3.0 to 15.0. Also, it was confirmed that C1 may be between 0.01 to 0.15 atm %, or preferably between 0.02 to 0.08 atm %. Further, it was confirmed that the slope a1 in the steep-change area may be 0.1 atm %/mm or greater, 0.2 atm %/mm or greater, 0.3 atm %/mm or greater, 0.5 atm %/mm or greater, or preferably 0.6 atm %/mm or greater. Also, it was confirmed that the coefficient of determination in the steep-change area was 0.70 or greater, or more preferably 0.75 or greater.

### Examples 18 to 21

Capacitor samples were manufactured similar to Example 1, and the similar evaluations were carried out; except that a coefficient of determination in the steep-change area and a slope a2 in the plateau area was controlled by adjusting the spattering amount of Mn. Results are shown in Table 4.

TABLE 4

| | | | | Steep-change area | | Plateau area | | Crack occurence ratio | |
|---|---|---|---|---|---|---|---|---|---|
| | Concentration | C1 | C2/ | Slope a1 | Coefficient of | Slope a2 | Coverage | Exterior | PCT (121° C., |
| Sample No. | difference | (at %) | C1 | (at %/mm) | determination | (at %/mm) | ratio (%) | inspection | 95% RH, 24 h) |
| Example 18 | Confirmed | 0.07 | 9.0 | 0.61 | 0.80 | 0.07 | 89.9 | 0/100 | 1/100 |
| Example 19 | Confirmed | 0.06 | 8.6 | 0.65 | 0.87 | 0.03 | 92.6 | 0/100 | 0/100 |
| Example 1 | Confirmed | 0.08 | 8.3 | 0.61 | 0.86 | 0.01 | 90.5 | 0/100 | 0/100 |
| Example 20 | Confirmed | 0.05 | 8.4 | 0.75 | 0.91 | −0.01 | 91.4 | 0/100 | 0/100 |
| Example 21 | Confirmed | 0.04 | 8.1 | 0.77 | 0.95 | −0.08 | 91.4 | 0/100 | 2/100 |

### Evaluation 6

As shown in Table 4, it was confirmed that the coefficient of determination of the slope a1 in the steep-change area was preferably 0.85 to 0.92 atm %/mm. Further, it was confirmed that the slope a2 in the plateau area was preferably within ±0.08 atm %/mm, within ±0.05 atm %/mm, or within ±0.03 atm %/mm.

### Examples 22 to 25

Capacitor samples were manufactured similar to Example 1, and the similar evaluations were carried out; except that a coverage ratio was controlled by regulating the adhering amount of electrode or an inhibitor amount. Results are shown in Table 5.

TABLE 5

| | | | | Steep-change area | | Plateau area | | Crack occurence ratio | |
|---|---|---|---|---|---|---|---|---|---|
| | Concentration | C1 | C2/ | Slope a1 | Coefficient of | Slope a2 | Coverage | Exterior | PCT (121° C., |
| Sample No. | difference | (at %) | C1 | (at %/mm) | determination | (at %/mm) | ratio (%) | inspection | 95% RH, 24 h) |
| Example 22 | Confirmed | 0.04 | 8.3 | 0.61 | 0.80 | −0.02 | 73.5 | 0/100 | 4/100 |
| Example 23 | Confirmed | 0.05 | 7.5 | 0.65 | 0.87 | 0.03 | 80.5 | 0/100 | 0/100 |
| Example 24 | Confirmed | 0.02 | 8.0 | 0.61 | 0.86 | 0.01 | 83.2 | 0/100 | 0/100 |
| Example 1 | Confirmed | 0.08 | 8.3 | 0.75 | 0.91 | 0.01 | 90.5 | 0/100 | 0/100 |
| Example 25 | Confirmed | 0.07 | 7.9 | 0.78 | 0.85 | −0.01 | 96.9 | 0/100 | 0/100 |

### Evaluation 7

As shown in Table 5, the coverage ratio was 70% or more, 80% or more, or preferably 90% or more.

### REFERENCE SIGNS LIST

1,1A . . . Multilayer ceramic capacitor
2 . . . Internal dielectric layer
3 . . . Internal electrode layer
4 . . . External electrode
10 . . . Element main body
10a . . . End face
R1 . . . End area
R2 . . . Center area

What is claimed is:

1. An electronic component comprising:
an element main body including an insulation layer and an electrode layer inside the element main body,
wherein a center side concentration of Mn in a center area of the electrode layer positioned near a center of the element main body is higher compared to an end side concentration of Mn in an end area of the electrode layer positioned near an end face of the element main body.

2. The electronic component according to claim 1, wherein the end side concentration of Mn is between 0.01 to 0.15 atm %.

3. The electronic component according to claim 1, wherein the end side concentration of Mn represented by C1 and the center side concentration of Mn represented by C2 satisfy C2/C1 of 1.1 to 20.0.

4. The electronic component according to claim 1, wherein a steep-change area, where a concentration of Mn drastically changes, exists between the end area and the center area of the electrode layer, and the steep-change area and the end area are continuous.

5. The electronic component according to claim 4, wherein the steep-change area appears in a range within 400 μm from the end face of the element main body.

6. The electronic component according to claim 4, wherein a Mn concentration change rate in the steep-change area is 0.1 atm %/mm or greater with respect to a distance (mm) along the electrode layer from the end face of the element main body.

7. The electronic component according to claim 4, wherein a plateau area, where the concentration of Mn barely changes, exists between the end area and the center area of the electrode layer, and the plateau area and the center area are continuous.

8. The electronic component according to claim 7, wherein the plateau area is observed in a range beyond 400 μm from the end face of the element main body.

9. The electronic component according to claim 7, wherein a Mn concentration change rate in the plateau area with respect to a distance (mm) along the electrode layer from the end face of the element main body is smaller than the Mn concentration change rate in the steep-change area.

10. The electronic component according to claim 1, wherein the end side concentration is an average of Mn concentrations obtained from three measuring points taking a predetermined space between each other along the electrode layer in the end area.

11. The electronic component according to claim 1, wherein the center side concentration is an average of Mn concentrations obtained from three measuring points taking a predetermined space between each other along the electrode layer in the center area.

12. The electronic component according to claim 1, wherein a slope of a linear approximation in a two-dimensional coordinate is 0.2 atm %/mm or greater and a coefficient of determination is 0.75 or greater, provided that the two-dimensional coordinate is set using a distance along the electrode layer from the end face of the element main body as an x-axis and using a concentration of Mn in the electrode layer at each measuring point along the x-axis as a y-axis, and a linear approximation of y is carried out where x is in a range between 20 μm to 100 μm.

13. The electronic component according to claim 1, wherein a main component of a conductor included in the electrode layer comprises Ni and/or a Ni-based alloy.

14. The electronic component according to claim 1, wherein the insulation layer comprises a dielectric layer including Ca and Zr.
